(19) United States
(12) Patent Application Publication
(10) Pub. No.: US 2015/0182306 A1
(43) Pub. Date: Jul. 2, 2015

(54) DENTAL BRACKET

(71) Applicant: Metal Industries Research and Development Centre, Kaohsiung (TW)

(72) Inventors: Ming-Hui Chen, Kaohsiung (TW); Wei-Hung Shih, Kaohsiung (TW)

(73) Assignee: Metal Industries Research and Development Centre, Kaohsiung (TW)

(21) Appl. No.: 14/143,337

(22) Filed: Dec. 30, 2013

(51) Int. Cl. A61C 7/14; A61C 7/16

(52) U.S. Cl. CPC A61C 7/143; A61C 7/16

(57) ABSTRACT

A dental bracket is adapted to connect with a wire for repositioning of a tooth in a mouth of a patient, and includes a base member, a cap, and an adjustable unit. The cap is connected removably to the base member to define an accommodating chamber therebetween, and is formed with an opening in spatial communication with the accommodating chamber. The adjustable unit includes an inner end portion disposed within the accommodating chamber and retained at a selected one of a plurality of angular positions, and an outer end surface formed with at least one wire engaging groove that is disposed outwardly of the opening in the cap. The cap is removable from the base member to allow for angular position adjustment of the inner end portion of the adjusting member relative to the base member.

### BACKGROUND OF THE INVENTION

1. Field of the Invention

This invention relates to an orthodontic device, and more particularly to a dental bracket.

2. Description of the Related Art

Referring to FIG. 1, during a dental orthodontic operation, a dental bracket 11 is adhered to a surface of a tooth of a patient, and a wire 12 is moved into contact with the dental bracket 11. Subsequently, a rubber band 13 is sleeved on the dental bracket 11 to fix the wire 12 between the rubber band 13 and the dental bracket 11. In this manner, the tooth can be moved gradually to an appropriate position.

Typically, the tooth is moved in the mouth by about 1 mm per month. For this reason, an angle of a straight section of the wire relative to an upright middle line (A) of the tooth must be adjusted at a time interval, so as to allow the tooth to move accurately to a predetermined position. However, since the wire 12 is fixed to the dental bracket 11 by the rubber band 13, a process for adjusting the angle of the straight section of the wire 12 relative to the dental bracket 11 includes the steps of removing the rubber band 13 from the dental bracket 11, removing the wire 12 from the dental bracket 11, removing the dental bracket 11 from the surface of the tooth, cleaning and sterilizing the tooth and the dental bracket 11, applying an adhesive (not shown) to the surface of the tooth, moving the dental bracket 11 to contact the surface of the tooth, moving the wire 12 to contact the dental bracket 11, and sleeving the rubber band 13 on the dental bracket 11. As a result, the angle adjustment of the straight section of the wire 12 is time-consuming and troublesome.

### SUMMARY OF THE INVENTION

The object of this invention is to provide a dental bracket that is configured to allow for a position adjustment of a wire without removing the dental bracket from a tooth.

According to this invention, a dental bracket is adapted to connect with a wire for repositioning of a tooth in a mouth of a patient, and includes a base member, a cap, and an adjustable unit. The cap is connected removably to the base member to define an accommodating chamber therebetween, and is formed with an opening in spatial communication with the accommodating chamber. The adjustable unit includes an inner end portion disposed within the accommodating chamber and retained at a selected one of a plurality of angular positions, and an outer end surface formed with at least one wire engaging groove that is disposed outwardly of the opening in the cap and that engages a straight section of the wire. The cap is removable from the base member to allow for angular position adjustment of the inner end portion of the adjusting member relative to the base member.

As such, the angle of the straight section of the wire relative to the tooth can be adjusted by removing the adjustable unit from the base, thereby resulting in convenience during use of the dental bracket.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a schematic view illustrating a conventional dental bracket;

FIG. 2 is an exploded perspective view of the first preferred embodiment of a dental bracket according to this invention;

FIG. 3 is a side view of the first preferred embodiment;

FIG. 4 is a perspective view of a cap of the first preferred embodiment;

FIG. 5 is a schematic front view of the first preferred embodiment, illustrating that a wire engaging groove is perpendicular to an upright middle line of a tooth;

FIG. 6 is a view similar to FIG. 5 but illustrating the wire engaging groove is inclined relative to the upright middle line of the tooth;

FIG. 7 is a perspective view of the second preferred embodiment of a dental bracket according to this invention; and

FIG. 8 is a schematic front view of the second preferred embodiment, illustrating that a wire engaging groove is inclined relative to a tooth.

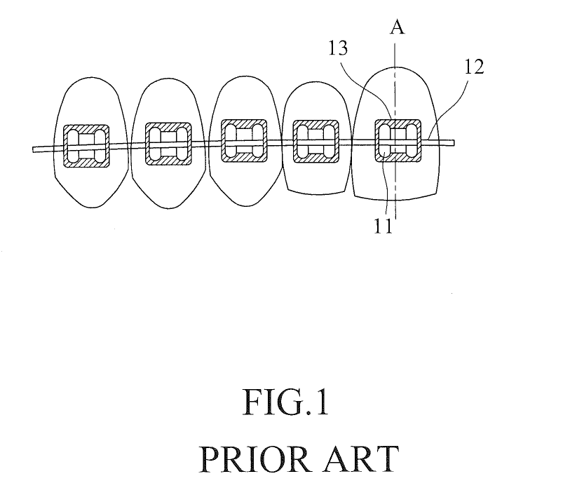

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

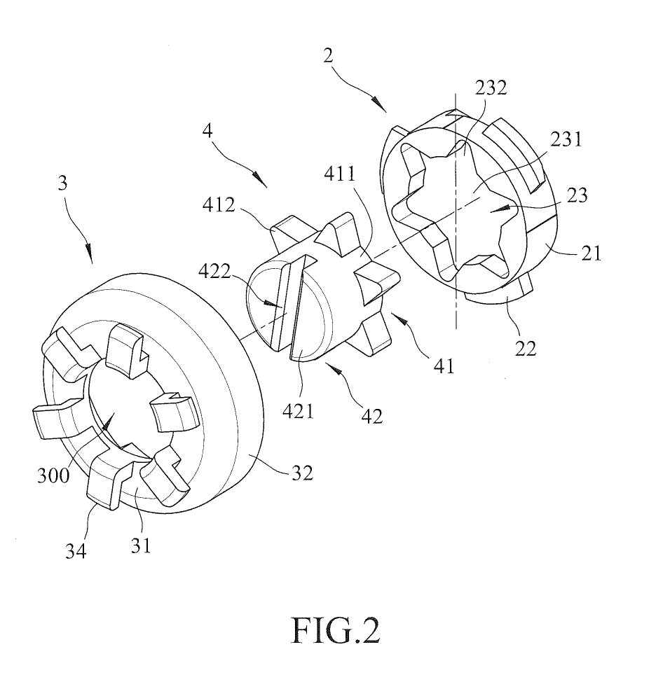

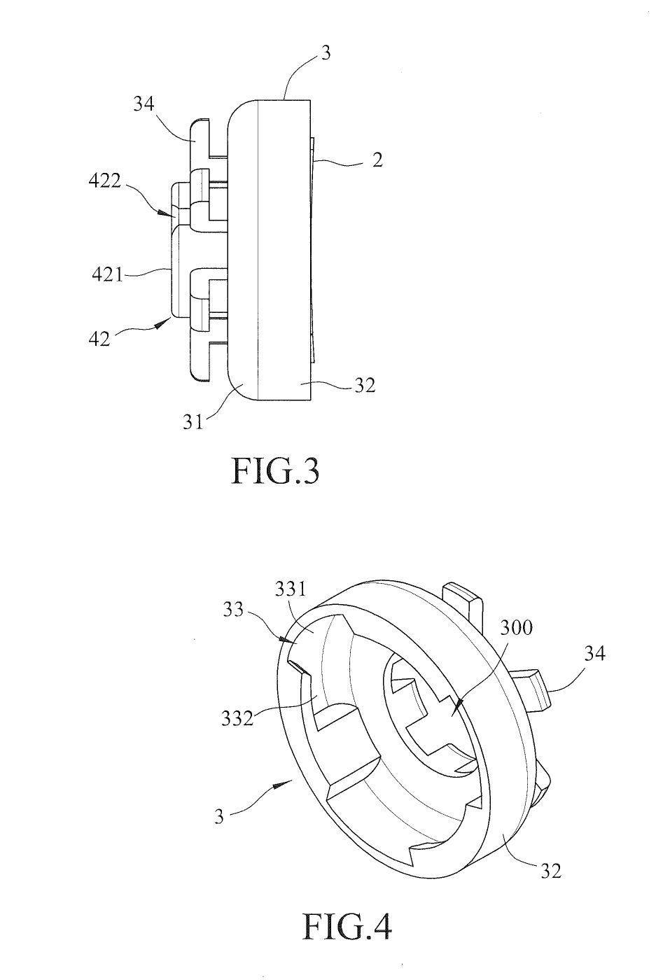

Referring to FIGS. 2, 3, and 4, the first preferred embodiment of a dental bracket according to this invention is adapted for repositioning of a tooth in a mouth of a patient, and includes a base member 2, a cap 3, and an adjustable unit.

The base member 2 is adhered to the tooth in a known manner, and has an imaginary upright middle line (B), and includes a base wall 21 and a plurality of anchoring blocks 22 formed on an outer peripheral surface of the base wall 21. The base wall 21 is formed with a retaining hole 23 that has a central hole portion 231 and a plurality of positioning hole portions 232 extending radially and outwardly from the central hole portion 231. In this embodiment, the retaining hole 23 is a blind hole. The positioning hole portions 232 are angularly equidistant.

The cap 3 is connected removably to the base member 2, and includes an outer end wall 31, a peripheral wall 32, a plurality of slide slots 33, and a plurality of hook members 34. When the cap 3 is retained on the base member 2, the anchoring blocks 22 are engaged respectively into the slide slots 33, and the cap 3 cooperates with the base member 2 to define an accommodating space therebetween. The retaining hole 23 forms a portion of the accommodating space. The outer end wall 31 is formed with an opening 300 in spatial communication with the accommodating chamber.

The peripheral wall 32 extends from an outer periphery of the outer end wall 31 toward the base member 2. The hook members 34 are arranged around the opening 300 and along an inner peripheral portion of the outer end wall 31, and extend from the outer end wall 31 away from the base member 2 for connection with a rubber band (not shown) such that a straight section of a wire (not shown) extends among the hook members 34. The slide slots 33 are formed in an inner surface of the peripheral wall 32, and permit the anchoring blocks 22 to be engaged respectively therein. Each of the slide slots 33 is L-shaped, and has a narrow slot portion 332 that engages a respective one of the anchoring blocks 22, and a wide slot portion 231 that is wider than the narrow slot portion 232 and that is sized to allow the respective one of the anchoring blocks 22 to move out of the narrow slot portion 232 therethrough. In this embodiment, the number of the slide slots 33 is three.

The adjustable unit only includes an adjusting member 4. The adjusting member 4 includes a main body or inner end portion 41 and a protrusion 42. The main body 41 has a base portion 411 fitted within the central hole portion 231 of the retaining hole 23, and a plurality of positioning projections 412 extending from the base portion 411 and fitted respectively within the positioning hole portions 232. In this embodiment, the main body 41 has six positioning projections 412. The protrusion 42 extends from the main body 41 and through the opening 300 in the cap 3, and has an outer end surface 421 formed with a straight wire engaging groove 422. The wire engaging groove 422 is disposed outwardly of the opening 300 in the cap 3, and permits the straight section of the wire to extend therethrough. The cap 3 is removable from the base member 2 to allow for angular position adjustment of the main body 41 relative to the base member 2. In this embodiment, since the number of the positioning projections 412 is six, when the adjusting member 4 is rotated by 60°, it can be positioned relative to the base member 2 by engagement between the positioning projections 412 and the positioning hole portions 232. Besides, after the adjusting member 4 is rotated by 180°, an angle formed between the wire engaging groove 422 and the imaginary upright middle line (B) is not changed. Accordingly, three diffident angles can be formed between the wire engaging groove 422 and the imaginary upright middle line (B).

During a dental orthodontic operation, the base member 2 is first adhered to a surface of the tooth. Next, the adjusting member 4 is placed into the base member 2 such that the positioning projections 412 are engaged respectively into the positioning hole portions 232 according to the desired angle.

Subsequently, the cap 3 is moved into contact with the base member 2 such that that anchoring blocks 22 are engaged respectively into the wide slot portions 331 of the slide slots 3 in the cap 3, and is rotated about its own central axis in a first direction to move the anchoring blocks 22 into the narrow slot portions 332 of the slide slot 3 to fix the adjusting member 4 between the base member 2 and the cap 3, such that the wire engaging groove 422 in the protrusion 42 is exposed from the cap 3. Finally, the rubber band is connected to the hook members 34 in a known manner so as to prevent movement of the straight section.

Upon a lapse of a preset time interval, when it is desired to adjust the angle of the wire engaging groove 422, the cap 3 is rotated about its own central axis in a second direction opposite to the first direction, so as to move the anchoring projections 22 from the narrow slot portions 332 into the wide slot portions 331, and the cap 3 is removed from the base member 2. At this time, the adjusting member 4 is rotated about its own central axis from one angular position, where one of the positioning projections 412 is aligned with one of the positioning hole portions 232, to another angular position, where the one of the positioning projections 412 is aligned with another one of the positioning hole portions 232. Thereafter, the positioning projections 412 are engaged respectively into the positioning hole portions 232 so that the angle formed between the wire engaging groove 422 and the imaginary upright middle line (B) is changed.

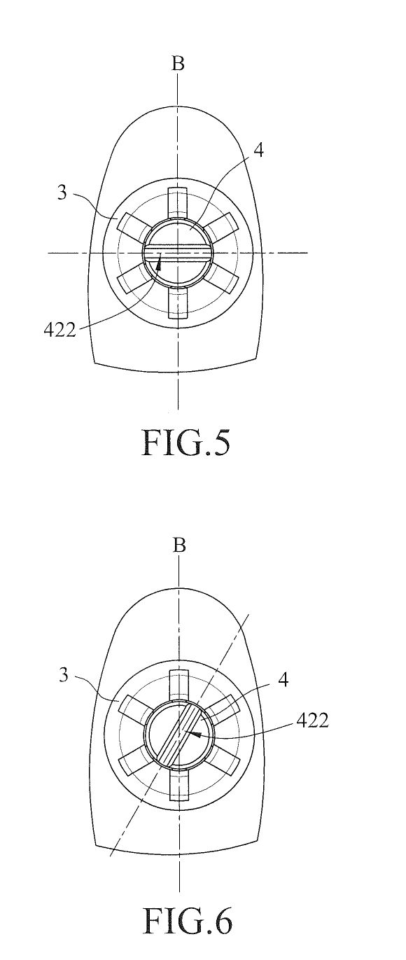

For example, the angle formed between the wire engaging groove 422 and the imaginary upright middle line (B) can be changed from an initial angle of 90° shown in FIG. 5 to a selected angle of 60° shown in FIG. 6 without removing the base member 2 from the tooth. Hence, the adjustable unit can be retained at a selected one of a plurality of angular positions.

As such, the dental bracket of this invention is easy and convenient to use.

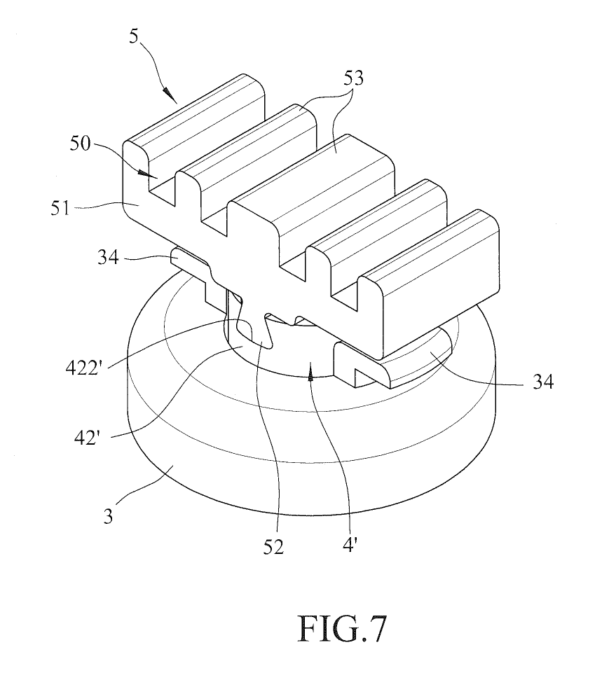

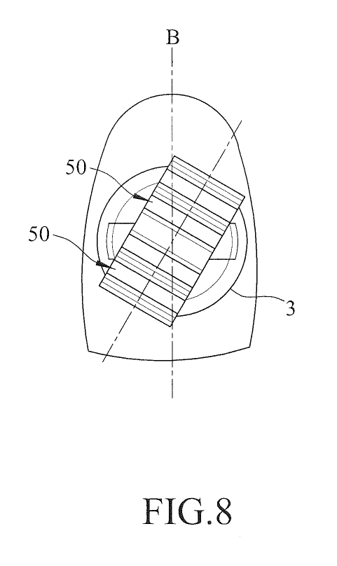

FIGS. 7 and 8 show the second preferred embodiment of a dental bracket according to this invention, which differs from the first preferred embodiment in that the adjustable unit 4 includes a connecting member 4′ and an adjusting member 5. The connecting member 4′ includes a main body having the same structure as the main body 41 (see FIG. 2) of the first preferred embodiment, and a protrusion 42′ extending from the main body and through the cap 3. The protrusion 42′ has an outer end surface formed with a dovetail groove 422′. The adjusting member 5 includes a base portion 51 configured as a rectangular plate, a dovetail tongue 52 extending from an inner side surface of the base portion 51 to engage the dovetail groove 422′ in a close fitting manner, and a plurality of parallel ribs 53 extending from an outer side surface of the base portion 52 for defining a plurality of parallel wire engaging grooves 50. Alternatively, the positions of the dovetail groove 422′ and the dovetail tongue 52 can be interchanged, i.e., the dovetail tongue 52 is disposed at the connecting member 4′, and the dovetail groove 422′ is disposed at the adjusting member 5.

In this embodiment, the wire is engaged into a selected one of the wire engaging grooves 50.

In this embodiment, since the angle of the straight section of the wire is adjusted by changing the angle formed between the imaginary upright middle line (B) and the straight section engaging grooves 50 and/or by moving the straight section among the wire engaging grooves 50, the position of the straight section of the wire relative to the tooth is easy and convenient to adjust.

In view of the above, a process for adjusting the position of the straight section of the wire relative to the tooth includes the steps of removing the cap 3 from the base member 2, removing the adjustable unit from the base member 2, rotating the adjustable unit relative to the base member 2 by an angle, assembling the adjustable unit to the base member 2, and assembling the cap 3 to the base member 2. As a result, during this process, it is not necessary to remove the base member 2 from the tooth. Thus, the object of this invention is achieved.

With this invention thus explained, it is apparent that numerous modifications and variations can be made without departing from the scope and spirit of this invention. It is therefore intended that this invention be limited only as indicated by the appended claims.

We claim:

1. A dental bracket adapted to connect with a wire for repositioning of a tooth in a mouth of a patient, said dental bracket comprising:
a base member adapted to be adhered to the tooth;
a cap connected removably to said base member to define an accommodating chamber therebetween, said cap being formed with an opening in spatial communication with said accommodating chamber; and
an adjustable unit including an inner end portion disposed within said accommodating chamber and retained at a selected one of a plurality of angular positions, and an outer end surface formed with at least one wire engaging groove that is disposed outwardly of said opening in said cap;
wherein said cap is removable from said base member to allow for an angular position adjustment of said inner end portion of said adjusting member relative to said base member.

2. The dental bracket as claimed in claim 1, wherein said adjustable unit further includes an adjusting member, said adjusting member including a main body constituting said inner end portion, and a protrusion extending from said main body and through said opening in said cap and having said outer end surface.

3. The dental bracket as claimed in claim 1, wherein said adjustable unit further includes an adjusting member having said outer end surface formed with a plurality of parallel said wire engaging grooves, and a connecting member including a main body constituting said inner end portion, and a protrusion extending from said main body and through said opening in said cap, said protrusion and said adjusting member being interconnected by engagement between a dovetail tongue and a dovetail groove, which engage each other in a close fitting manner, said dovetail tongue being disposed at one of said protrusion and said adjusting member, said dovetail groove being disposed at the other of said protrusion and said adjusting member.

4. The dental bracket as claimed in claim 1, wherein said base member includes a base wall formed with a retaining hole, said retaining hole having a central hole portion and a plurality of positioning hole portions extending radially and outwardly from said central hole portion, said inner end portion of said adjusting unit having a base portion fitted within said central hole portion of said retaining hole, and a plurality of positioning projections extending from said base portion and fitted respectively within said positioning hole portions.

5. The dental bracket as claimed in claim 4, wherein said positioning hole portions of said retaining hole are angularly equidistant.

6. The dental bracket as claimed in claim 4, wherein said base wall has an outer peripheral surface, and said base member includes a plurality of anchoring blocks formed on said outer peripheral surface, said cap including an outer end wall formed with said opening, a peripheral wall extending from an outer periphery of said outer end wall toward said base member, and a plurality of slide slots formed in an inner surface of said peripheral wall and engaging respectively said anchoring blocks.

7. The dental bracket as claimed in claim 6, wherein each of said slide slots is L-shaped, and has a narrow slot portion that engages a respective one of said anchoring blocks, and a wide slot portion that is wider than said wide slot portion and that is sized to allow the respective one of said anchoring blocks to move out of said narrow slot portion therethrough.

8. The dental bracket as claimed in claim 6, wherein said cap further includes a plurality of hook members extending from said outer end wall away from said base member and adapted for connection with a rubber band such that the wire extends among said hook members.

9. The dental bracket as claimed in claim 8, wherein said hook members are arranged along an inner peripheral portion of said outer end wall.
